(19) United States
(12) Patent Application Publication
(10) Pub. No.: US 2026/0187932 A1
(43) Pub. Date: Jul. 2, 2026

(54) SYSTEM AND METHOD FOR CREATING 3D MODEL DATA

(71) Applicant: FITIX VISUALIZATION LTD., Tel Aviv (IL)

(72) Inventors: Ran BUCHNIK, Tel-Aviv (IL); Ziv HAHAM, Yehud (IL); Yehiel ATIAS, Tel-Aviv (IL); Yuval FROMMER, Tel-Aviv (IL)

(21) Appl. No.: 19/129,013

(22) PCT Filed: Nov. 13, 2023
(86) PCT No.: PCT/IB2023/061426

§ 371 Date: May 11, 2025

Related U.S. Application Data
(60) Provisional application No. 63/425,398, filed on Nov. 15, 2022.

(51) Int. Cl. G06T 17/20; G06T 7/00; G06T 7/33; G06T 7/40; G06T 7/60; G06T 9/00; G06T 15/04; G06T 15/20; G06T 15/50

(52) U.S. Cl. CPC G06T 17/20; G06T 7/344; G06T 7/40; G06T 7/60; G06T 7/97; G06T 9/001; G06T 15/04; G06T 15/20; G06T 15/50; G06T 2200/24; G06T 2207/30168

(57) ABSTRACT

A system for producing a three dimensional model incudes functionalities of: presenting to a user a reference image of an item and facilitating uploading of a three dimensional model created by the user of the same item. The system then also being designed for obtaining parameters of a unique camera matrix in which a rendering of the three dimensional model appears substantially similar the reference image.

### TECHNICAL FIELD

Embodiments of the invention relate to a system and method for creating 3D model data, for example by comparing three dimensional data to one or more reference images, for example in order to create or adjust the three dimensional data from the reference image.

### BACKGROUND

In online retail two dimensional images are traditionally used for representing items that are offered for sale. Three dimensional models however are becoming increasingly important in online retail as shoppers search for a more immersive online shopping experience. Therefore, using high-quality 3D models in this commercial domain provides customers with a more realistic view of what they may be searching to purchase and increase the likelihood that a purchase may take place.

Computer systems can be used for generating 2D views of a 3D object. They typically render a 3D graphic of the object by projecting a mesh of polygons representing the object into 2D space based on a point of view of a camera that records images of the object.

Efficient ways are available for describing details of such objects so they can easily run on a variety of commonly used computer systems. For example, a surface of the 3D object can be defined by a texture map that is a manner for describing the details of the image. The texture map is a 2D array of texture pixels and may represent color, reflectivity, surface roughness, transparency, or other attributes.

Such computer systems and methods can be used for bridging the domain gap between 2D and 3D data and can be used for a variety of needs, such as in the online retail space for increasing sales and exposure to potential customers.

### SUMMARY

The following embodiments and aspects thereof are described and illustrated in conjunction with systems, tools and methods which are meant to be exemplary and illustrative, not limiting in scope.

In an aspect relating to at least certain embodiments of the invention there is provided a method of visually comparing an object as it is represented in a 3D model to its representation in one or more given ‘reference’ images—as a part of a 3D model generation process quality control.

The model may be manually/semi-automatically/automatically generated. The model may be represented as a Mesh (e.g., triangular) accompanied by material properties and texture maps in formats such as OBJ/STL/GLB/GLTF. The model may also be represented as a point cloud, or volumetrically, e.g., as a voxel grid or an SDF, or implicitly, e.g. as the decision boundary of a non-linear classifier, as for example in variations of Neural Radiance Fields.

In at least certain embodiments, the process may involve three main stages. An alignment stage, a quality control stage in the form of Visual Feedback, and an automation of Quality Control stage.

In at least certain embodiments, in the alignment stage a transformation may be found, which allows for pixel-wise comparison between an object, as it is represented in a 3D model and in a given reference image.

In certain embodiments, in the quality control stage, the alignment transformation found in the alignment stage may be used to create pixel-aligned synthetic images (AKA ‘renders’) of different properties of the 3D model. The pixel-aligned renders may then be displayed substantially in the same coordinate system as a reference image. This solves the correspondence problem, making discrepancies between a reference image and the model self-evident and easy to locate.

The discrepancies may then be communicated by means which are easily interpretable by both human and machine, such as detection bounding boxes, segmentation masks, etc., allowing for automation of such quality control efforts, e.g., by means of Machine/Deep Learning algorithms.

In at least certain embodiments, in the Automation stage a set of algorithms may be provided in order to localize discrepancies between a reference image and the synthetic render.

In an embodiment, in the alignment stage-a reference image of an object, and a 3D model depicting that same object may be provided, with a possible objective being to form a representation that allows for detection of discrepancies between the object as it is represented in the reference image and in the 3D model.

In an embodiment, an output of this process may be a synthetic image (render) of the 3D model, such that the reference image and the synthetic image are ‘aligned’, in the sense that they depict the object e.g. in the same location and pose.

Possibly, an equivalent required output may be a synthetic camera, as described by camera parameters, such that the image of the 3D model rendered by the synthetic camera may be substantially aligned to a reference image—so that alignment may be thought of as the process of finding a set of camera parameters (location(x3), orientation(x3), focal length/FOV, and potentially the optical center, also known as the principal point, and the skew coefficient.).

In an embodiment, a method may be provided of finding the set of camera parameters. In certain cases the camera parameters can be given, or done in a manual, semi-automatic, and automatic fashion.

Camera parameters can be given e.g. in case that the model was reconstructed e.g. using Structure from Motion methods (or the like).

Manual alignment may be provided by a UI that enables manually adjusting the location, orientation, focal length of the model with respect to a reference image.

Semi-automatic alignment may be provided by enabling a user to specify a set of corresponding points in the reference image and the 3D model. The camera parameters may then be retrieved by solving the Perspective N Point problem.

Automatic alignment may be done in several ways. For example, the first part of the semi-automatic approach may be automated, and then the process may proceed by solving the Perspective N Point problem. Namely the method may employ applying classical (SIFT/SURF/ORB/etc.) or learning based (SuperPoint, etc.) approaches for detection, description, and matching of corresponding interest points in a image and the render.

In another example, a method may employ directly optimizing a differential renderer to minimize a distance measure based on differences between image and render. In terms of pixel values, masks or silhouettes.

Intrinsic Image Decomposition may be provided in the following. For example for pbr materials several ways may be provided for representing the material properties. For example, in certain cases use may be made of a metalness/roughness material, or a specular/glossiness material. The output of both types may be basically the same—however, each method may have different data information stored differently across the maps.

Metallic-Roughness materials may be configured to use any one of: Base color, Metallic and Roughness maps. Specular-Glossiness materials may be configured to use any one of: Albedo (also called diffuse), Specular and Glossiness

In certain cases there may also be use of either a bump map or a normal map to present/enhance surface details.

Additionally, an emissive map may be used in certain cases to simulate lights\parts that have their own light sources coming out of the material, and an opacity\alpha map that dictates the transparent areas in the material.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIGS. 1A and 1B schematically show block diagrams representing possible modules that may be implemented in at least certain computerized system embodiments for comparing three dimensional data to reference image(s) and/or for producing three dimensional data from reference image(s);

FIGS. 2A to 2C schematically show a user interface of an embodiment of a computerized system, where the screens being shown are of a possible alignment module of the system;

FIG. 3 shows a table exemplifying several comparison modes that may be available in a review module of an embodiment of the system;

FIGS. 4A to 4C, 5A to 5C and 6A to 6C exemplify some of the comparison modes listed in the table of FIG. 3;

FIG. 7 shows a table exemplifying further comparison modes that may be available in a review module of an embodiment of the system;

FIGS. 8A and 8B exemplify some of the comparison modes listed in the table of FIG. 7;

FIGS. 9 to 11 schematically shows several functions that may be available in a feedback module of the system;

FIGS. 12 to 18 schematically show additional functions that may be used in various system embodiments, during various stages of review and/or production of 3D models with respect or from reference image(s);

FIG. 19 schematically shows a user interface of an embodiment of a computerized system, where a 3D model is shown aside two reference images that were used for creating the model; and

FIGS. 20A to 20C schematically show one example for creating an automated correction of a 3D model.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

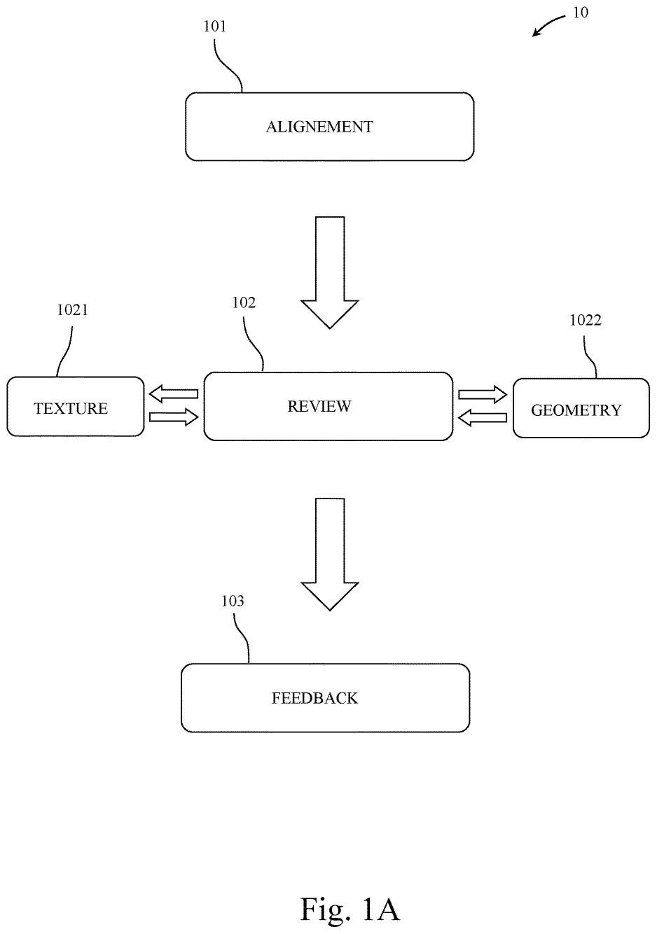

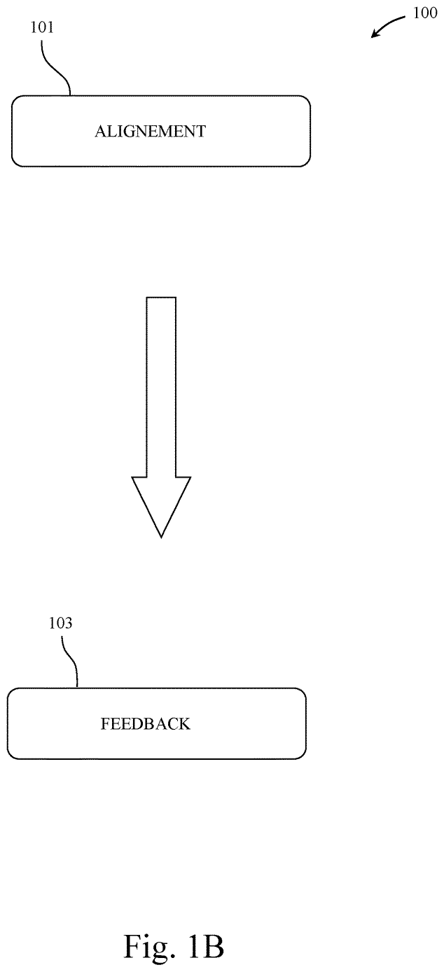

Attention is first drawn to FIGS. 1A and 1B schematically showing block diagrams 10 and 100, respectively, representing possible modules that may be implemented in at least certain computerized system embodiments for comparing three dimensional (3D) model data to two dimensional (2D) reference image(s) and/or for producing three dimensional data from reference image(s).

A graphical user interface (UI) may be provided for controlling the computerized system. The user interface (UI) may be accessed by a browser running on a user's computer or other internet-connected device. In the case where the computerized system is accessed locally (e.g. not via the internet) the UI may run locally (i.e. not via a browser).

The 3D model may be a 3D representation of an item seen in one or more reference images, and may be created in a variety of techniques. For example, a series of 2D reference images of an item can be used to create a 3D model of the item e.g. through photogrammetry; a 3D model of an item may be created from one or more 2D reference images of the item by a designer (etc.). The item in at least certain embodiments may be a real world item or object. In some cases, the item may not necessarily be a real world item or object, and hence the reference images may e.g. be sketches, CAD images (or the like).

The computerized system may be used for streamlining production of 3D models of items from one or more reference images of such items in a variety of ways. For example, reference images for which 3D models are required may be exhibited to users having access to a UI of the system. A user may choose the one or more reference images associated with an item that he/she wants to model and may create the model, possibly off-line, and then possibly re-engage with the UI in order to upload the 3D model to the system.

The modules seen in FIG. 1A may be used for visually comparing an item as it is represented in a 3D model to its representation in its given one or more ‘reference’ images—as part of a 3D model generation process quality control phase.

The modules here seen are: alignment module 101, review module 102 and feedback module 103.

In certain embodiments, in order to compare a 3D model of an item to a given reference image of the same item, the 3D model preferably needs to be observed using substantially the same camera parameters that were used for capturing the given reference image of the item.

In other words, in order to be able to make a correct comparison to a given reference image of an item—in certain embodiments—substantially the same unique camera matrix (also referred to as projection matrix) that was used for capturing the given 2D reference image of the same item, should preferably be used for projecting a view of the item from the 3D model into 2D space.

In certain cases, a unique camera matrix relating to each reference image that was used for creating a 3D model, may be provided together with the 3D model—so that the 3D model can later be viewed using the unique camera matrix associated with each given reference image when comparing to said given reference image.

However in other cases, for each given reference image that was used for creating a 3D model, an alignment stage may be needed in order to obtain the respective unique camera matrix to be used for viewing the 3D model at substantially the same camera parameters in which the 2D view of the given reference image was captured.

In accordance with various embodiments of the invention, this alignment may be performed automatically, semi-automatically or manually.

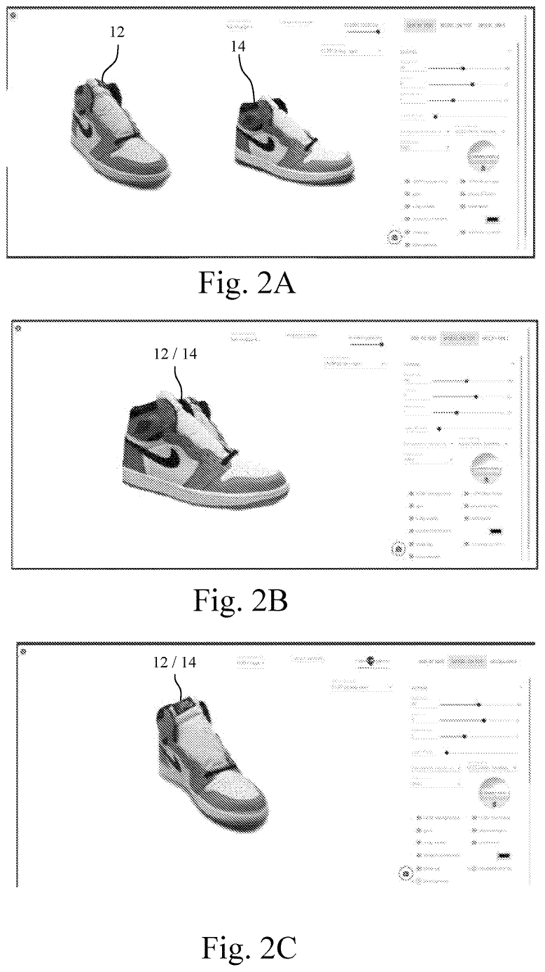

Attention is drawn to FIGS. 2A to 2C schematically showing possible screens of a UI that may be used in the alignment module of a system such as that illustrated in the block diagrams of FIGS. 1A and 1B. The UI in this example can be seen optionally exhibiting a reference image 12 of a given item and a 3D model 14 of the same given item. It is noted that reference image 12 may be part of a group of reference images (not shown here) that were used for creating the 3D model.

FIG. 2A represents a possible state prior to alignment, where the reference image 12 of the item (in this example a sports shoe) and a 3D model 14 of this same item—are placed in this example one aside the other.

As seen in FIGS. 2B and 2C, a user may be assisted by the UI in aligning the model 14 with the reference image 12, e.g. by dragging the model 14 onto the reference image 12 and then adjusting the orientation of the 3D model until it appears substantially aligned with the reference image 12.

Once the user is satisfied with the alignment, the parameters of the unique camera matrix used for viewing the 3D model in this aligned position with respect to the reference image may be obtained. This process may be repeated for each reference image that was used for creating the 3D model in order to obtain a unique camera matrix that is associated with each reference image and its model.

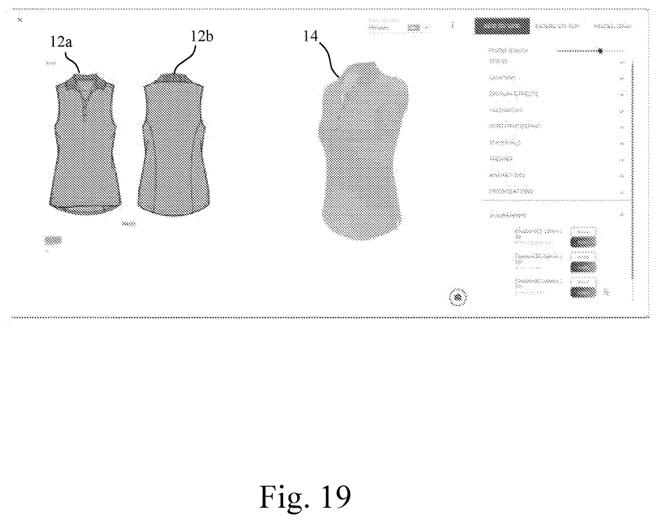

FIG. 19 shows an example of a UI where two references images 12a and 12b of an item are provided together with a 3D model 14 of the item. Here the reference images can be seen being in the form of non-real world sketches of the item from its front and back sides. For each such reference image, a camera matrix may be obtained—so that the 3D model may be toggled each time to be viewed in the suitable orientation for enabling comparing to its reference image.

An automatic or semi-automatic alignment may also be performed by choosing corresponding points on both the 3D model and the reference image, and then these corresponding points may be used in order to adjust the view of the 3D model so that it generally correlates to the reference image- and by that the unique camera matrix can be obtained.

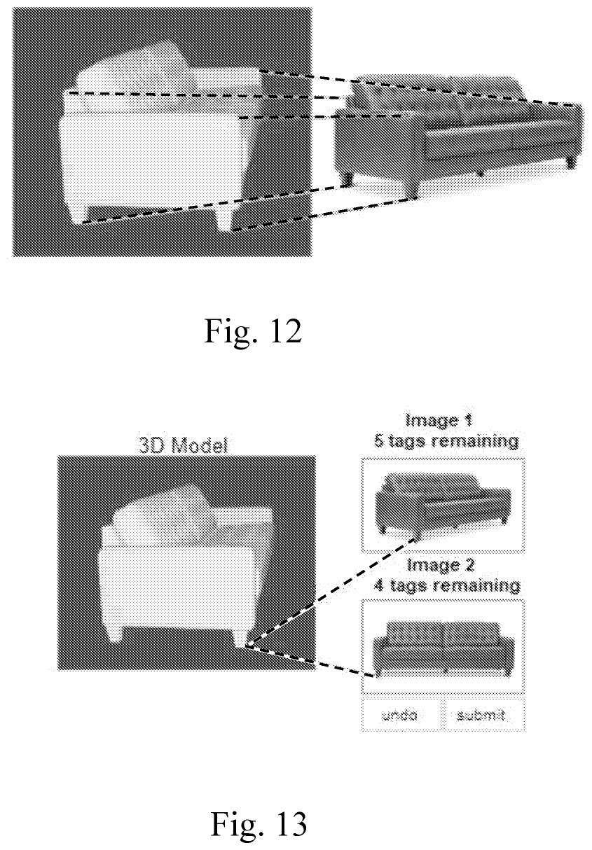

Attention is drawn to FIG. 12 illustrating such corresponding points being linked by, possibly imaginary, dashed lines. Such corresponding points may be manually and/or automatically chosen on a 3D model (see at the left hand side of the figure) and on a reference image (see at the right hand side of the figure) that was used for creating the 3D model.

With attention additionally drawn to FIG. 13, an optional procedure can be seen for choosing corresponding points on a 3D model and on more than one of its reference image (here two reference images) that were used for creating the 3D model.

In this example, a UI screen is shown for guiding a user performing such alignment manually, to ‘tag’ (i.e. ‘choose’) a certain number of corresponding points, possibly a pre-defined number, for each one of the reference images. With respect to reference image 1, after ‘tagging’ one point, the user is guided to optionally ‘tag’ five more points; and with respect to reference image 2, after ‘tagging’ one point, the user is guided to optionally ‘tag’ four more points. Points used for alignment may be any number, preferably at least three and possibly more e.g. six, seven, eight (or the like).

Unique camera matrices obtained in various techniques (manual, automatic, semi-automatic, etc.) may accordingly be stored and associated with each reference image that was used for creating the respective 3D model-so that they can be used at a later stage, e.g. in later comparisons of other versions of the same 3D model to each one of the reference image(s).

In certain cases, the unique camera matrix may be updated as the comparison of the 3D model to its references image evolves—in order to present a more precise alignment between the two. Such an update may be due to various reasons, such as when the 3D model is improved/fine-tuned to better represent the item seen in the reference image (or the like)—hence permitting a better possible alignment (i.e., unique camera matrix) to be obtained.

In certain cases, alignment may be performed and used for “self-feedback” e.g. by and/or for a designer of a 3D model. Viewing the 3D model and the reference image aligned may be useful in exposing at least certain errors as self-evident by visual inspection.

In certain cases, an overall alignment score may be provided and derived in various ways. For example, in cases where alignment may be provided by choosing corresponding points on the 3D model and the reference image (either manually or automatically), distances between corresponding points after the alignment is performed may be used for deriving such a score.

In one example, an average of such distances between corresponding points, may be used for deriving such a score. In other examples, a binary mask, an Intersection over Union (IoU) metric (or the like) may be used for deriving such a score for quality of alignment. In other examples, a score may be computed based on the differences between foreground binary mask, or silhouette, e.g. based on an Intersection over Union (IoU) metric (or the like).

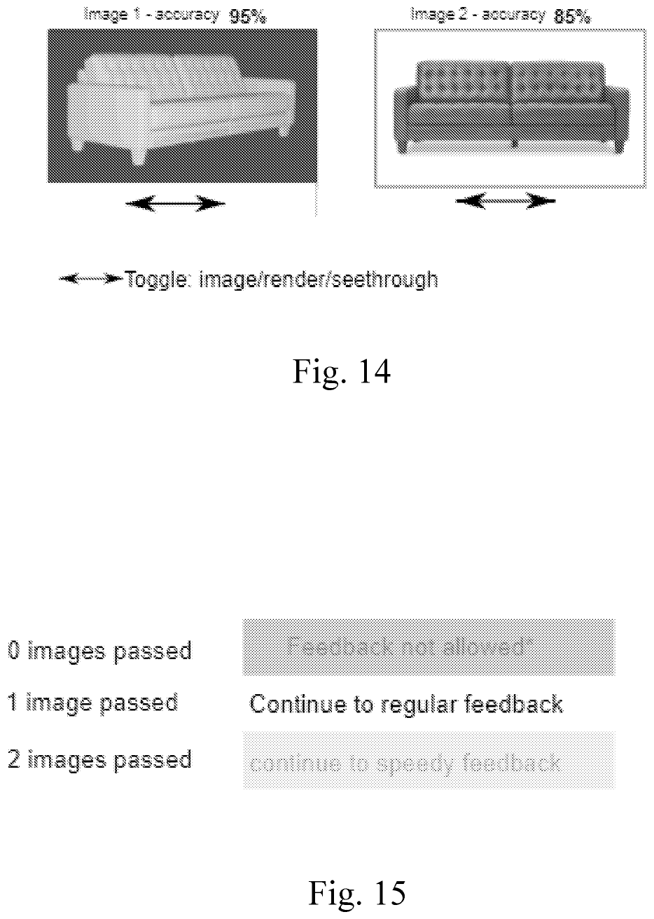

With attention drawn to FIG. 14, an example of providing a score of alignment between a 3D model and references images used for creating the 3D model can be seen. In this example, with respect to reference image 1, an alignment score of 95% was obtained- and with respect to reference image 2, an alignment score of 85% was obtained.

FIG. 15 illustrates an option of feedback that may be given in a module of the system such as feedback module 103. As seen, the score may be divided into several “buckets” (here three such “buckets”) according to score value. In this example, zero reference images received an alignment score that does “not allow” the 3D production process to proceed, one reference image received an alignment score that allows the 3D production process to proceed along a “regular” route, and two references images received an alignment score that allows the 3D production process to proceed along a “speedy” route.

As illustrated in the block diagram of FIG. 1B, in certain cases, the system 100 may be configured to automatically point out potential erroneous areas and possibly also the type of the potential error- and hence directly provide feedback to the user, possibly without necessity of a review module 102 that will be described in more detail herein below. Possibly, the production process of the 3D model may also be automated. Examples of such automatic pointing to potential erroneous areas and possibly also the type of the potential error will be later described herein below, e.g. with respect to discussion relating to FIG. 17

Examples of automating the production of the 3D model may include the following. Automatically optimizing the model shape to better fit the reference image, e.g., by using a differential renderer. Automatically coloring/texturing the model, e.g. via texture projection, as for example is done in Structure from Motion (SFM) pipelines. Making domain adaptation more efficient, e.g. as in pix2pix (paired image to image translation) vs CycleGAN (unpaired image to image translation), (and the like).

Alignment may assist in making automation of feedback more feasible, since it may be seen as solving the basic problem of model-image correspondence. After alignment, each pixel corresponds to both a point in the reference image, and on the 3D model, and thus allows for pixel-based (or patch-based/region-based) comparison of different properties of the object, as it is described in the image and in the model.

Automated feedback of geometry may include for example comparing the pixels occupancy, i.e., if it belongs to the model it should also belong to the foreground mask, and vise-versa. Other tests may include consistency between shape curvature and image shading, etc.

Automated feedback of texture may include for example comparing the colors (or Hue, Saturation, etc.) of a pixel or region in the reference image and the render of the 3D model. For example, the comparison may be based on the different material properties (base color, reflective properties, etc.) of the model in the parts corresponding to that image pixel or region.

This representation of corresponding regions over image layers lends itself to further automating the development of such algorithms as described above, or to the tuning of their parameters, using machine learning techniques. Specifically, the transformation from input representation of image layers to the output domain of bounding boxes or segmentation masks may be accomplished using techniques, such as Convolutional Neural Networks, Transformers, and the like, in architectures such as YOLO, Mask R-CNN, etc.

Automated feedback solutions may be applied in a few manners, communicating with the artist or the QA manager. In certain cases, automated solutions may be used for taking actions, such as approve or disapprove a mode, make correction suggestions, make automated corrections to the 3D model, or point out potential pitfalls.

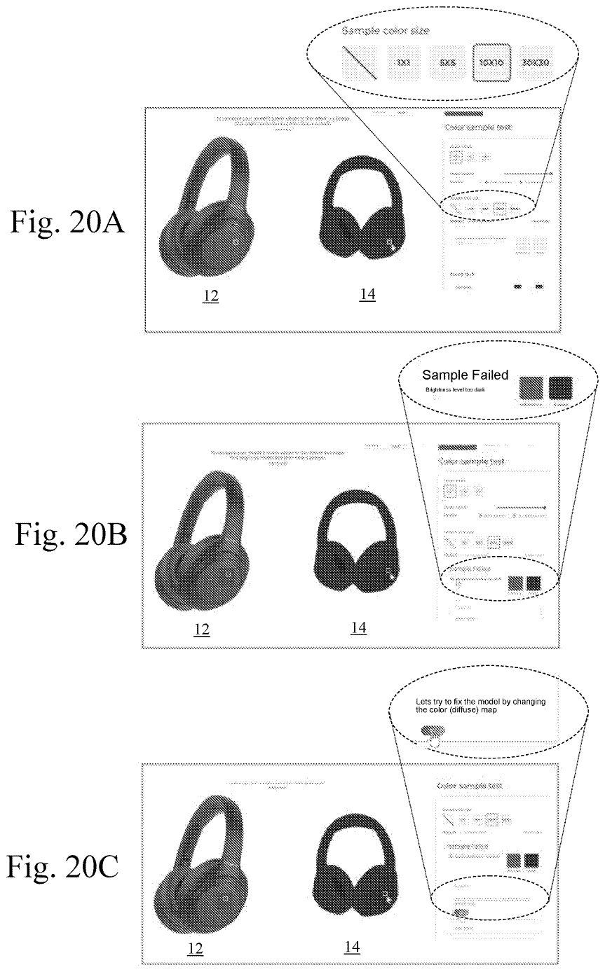

Attention is drawn to FIGS. 20A to 20C showing one option of automated correction that may be implemented in at least certain embodiments. In FIG. 20A a 3D model 14 is viewed using its camera matrix aside a reference image 12. Here a sample color size (in pixels) is shown provided in the UI and a user chose a 10×10 pixel size window for conducting comparisons between the model and the reference image. The corresponding 10×10 pixel size regions of comparison are indicated by the white rectangles marked on the model 14 and reference image 12.

In FIG. 20B a possible notice can be seen being provided to the user conducting this comparison that the brightness level in this example does not correspond between the same region on the model and reference image. In FIG. 20C a toggle can be seen provided in the UI enabling automated correction of this region within the model that was inspected.

For a designer of a 3D model, the alignment itself as aforementioned may be useful in making some discrepancies self-evident, encouraging self-feedback. The mentioned global alignment score may be used to stop/accelerate the feedback process, while local discrepancy detection may be used to point out potential errors in the model.

In certain cases, in addition to alignment and obtaining a camera matrix that assists in viewing a 3D model and a reference image in substantially the same orientation, further visualization components may be taken into consideration to ensure that a 3D model being viewed/corrected (e.g. during production) will be correctly displayed in a ‘3D model viewer’ of an end client/user where it is intended to be displayed and used during its final use.

For example, viewing a 3D model (e.g. during its production) may take into consideration the “scene lighting” that will be used in a ‘3D model viewer’ of an end client/user that will be using the 3D model for example in a web-site (or the like). A “scene lighting” is a generic term that encompasses both punctual light sources (such as point lights or spotlights) and ambient/environmental lighting used when viewing a 3D model in a ‘3D model viewer’. In computer graphics and 3D modeling, such “scene lighting” is an aspect that determines how objects in a scene are illuminated and how they appear to the viewer.

In a further example, a ‘rendering engine’ used for generation of the visual representation of 3D models in a ‘3D model viewer’ of an end client/user may also be taken into consideration when viewing/correcting a 3D model (e.g. during its production).

Attention is drawn back to the block diagram of FIG. 1A. Once an alignment has been accomplished, the UI may guide the user to a subsequent review module 102 phase. The review module 102 in the example seen in FIG. 1 may include two sub-sections of geometry 1021 and texture 1022 reviews.

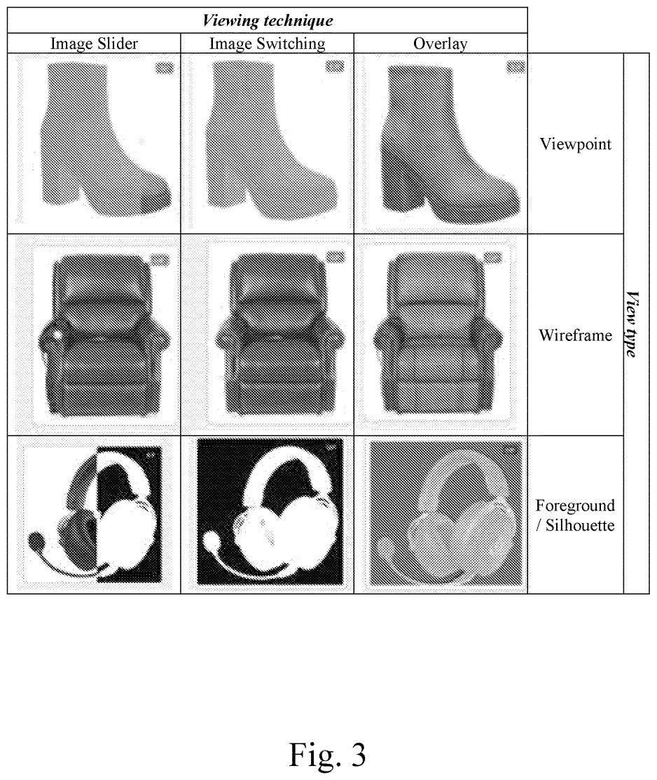

Attention is drawn to the table seen in FIG. 3 exemplifying several comparison modes that may be available in the geometry sub-section 1021 of the review module, with the purpose of these modes being at assisting in comparison to the reference image of parameters of the 3D model that generally relate to its geometry.

Each comparison mode may be formed by applying a certain viewing technique (as listed in the columns) to a certain view type (as listed in the rows). The optional viewing techniques as listed in the columns from left to right are: image slider, image switching and overlay—and the optional view types as listed in the columns from top to bottom are: viewpoint, wireframe and Foreground mask/Silhouette.

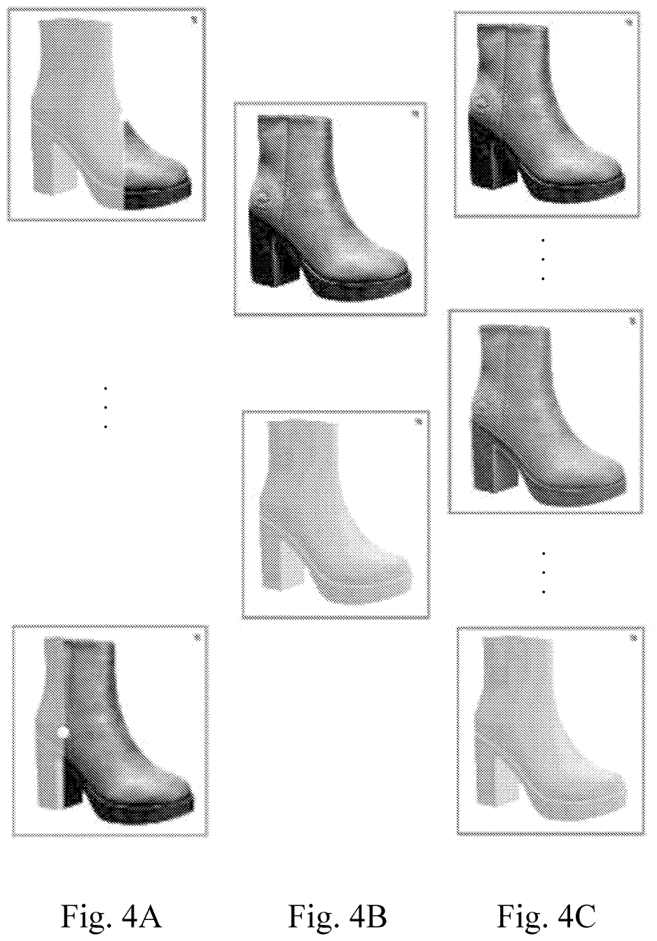

FIGS. 4A to 4C exemplify the three viewing techniques applied to the first view type.

The views seen in FIG. 4A illustrate comparison between the reference image and a rendering of the aligned 3D model using an image slider. Moving the image slider, automatically or manually, e.g. leftward (as seen in the transition from the top to the bottom image)—continuously and gradually reveals in this example the reference image (on the right hand side of the slider) while gradually hiding the 3D model (on the left hand side of the slider).

The slider may move back and forth revealing and hiding each time another one of the images—to assist a user in revealing discrepancies between the rendering of the 3D model and the reference image. The back and forth movement of the slider can be sideways as shown in this example or in other directions such as upwards and downwards.

Switching images as seen in FIG. 4B may mean switching in sequence between the reference image and the aligned view of the 3D model. Such switching may be automatically controlled or controlled by a user, e.g. by pressing the arrows on the keyboard (or the like). And the overlay viewing technique as seen in FIG. 4C may mean continuously and gradually overlaying one image over the other until the one image fully overlays the other and then in a reverse order until the other image becomes fully exposed.

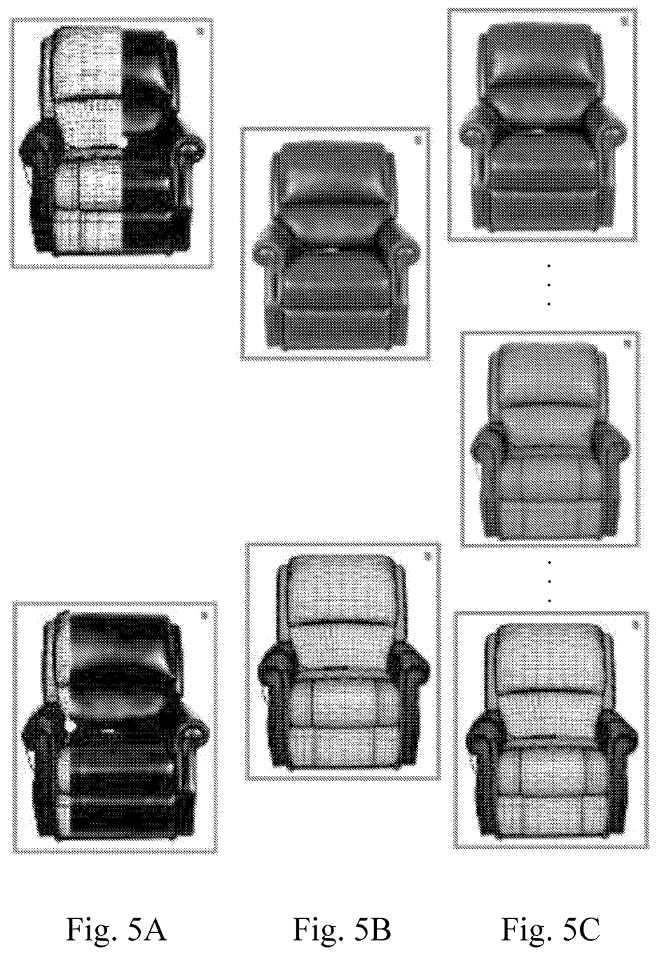

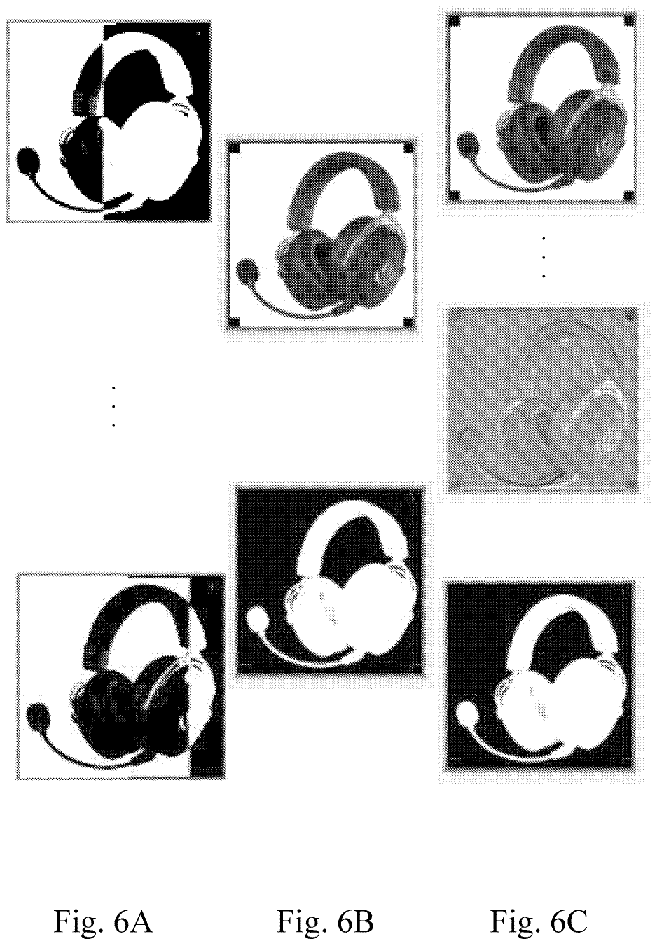

FIGS. 5A to 5C and 6A to 6C show how the same viewing techniques can be applied to the second and third view types, in this optional example of wireframe and foreground mask, respectively.

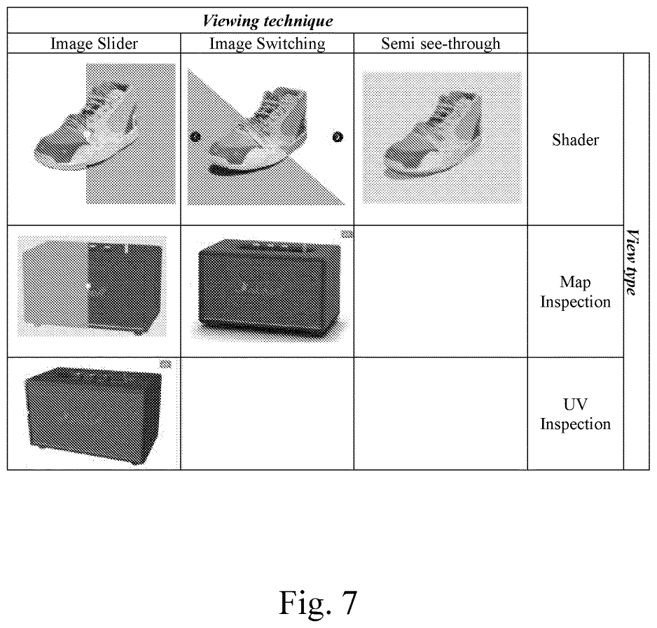

Attention is drawn to the table seen in FIG. 7 exemplifying several comparison modes that may be available in the texture sub-section 1022 of the review module, with the purpose of these modes being at assisting in comparison to the reference image of parameters of the 3D model that relate to its texture.

In a generally similar manner to the table of FIG. 3, each comparison mode may be formed by applying a certain viewing technique (as listed in the columns) to a certain view type (as listed in the rows). The optional viewing techniques as listed in the columns from left to right are: image slider, image switching and Semi see-through—and the optional view types as listed in the columns from top to bottom are: Shader, Map Inspection and UV Inspection.

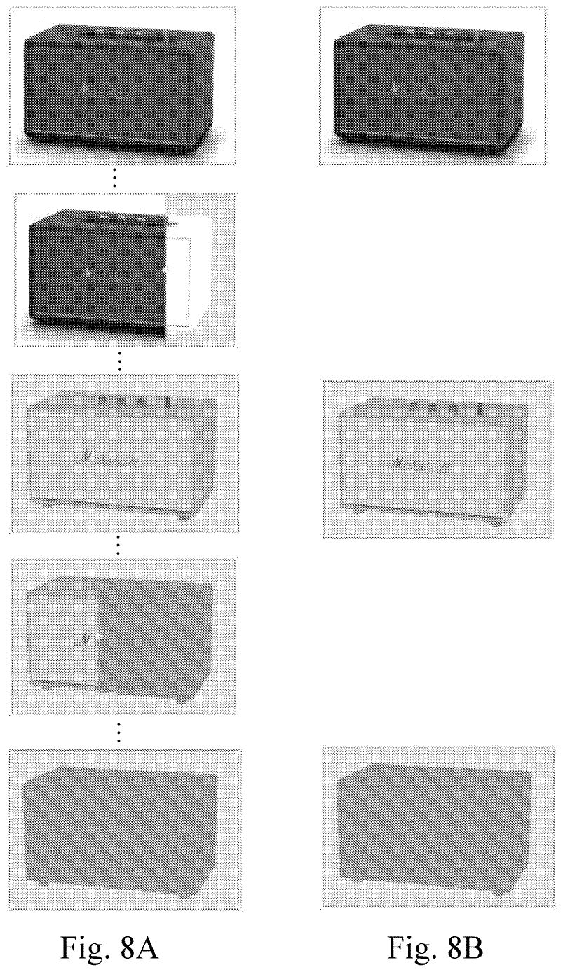

FIGS. 8A and 8B exemplify the two viewing techniques of applied to the second view type of image slider and image switching, being applied to the second view type of Map Inspection.

Once the review of a model has been finished, the UI may guide the user to a subsequent feedback module 103 phase.

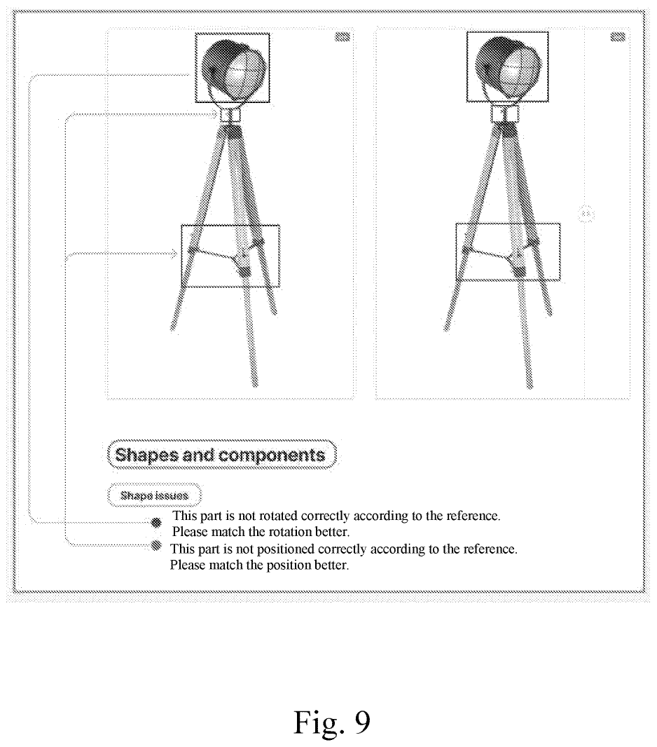

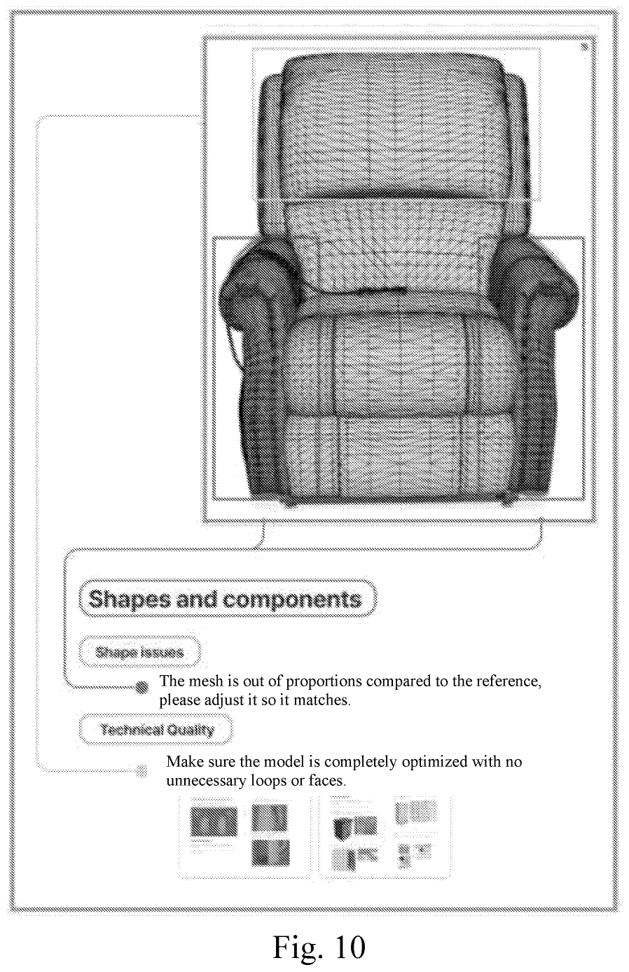

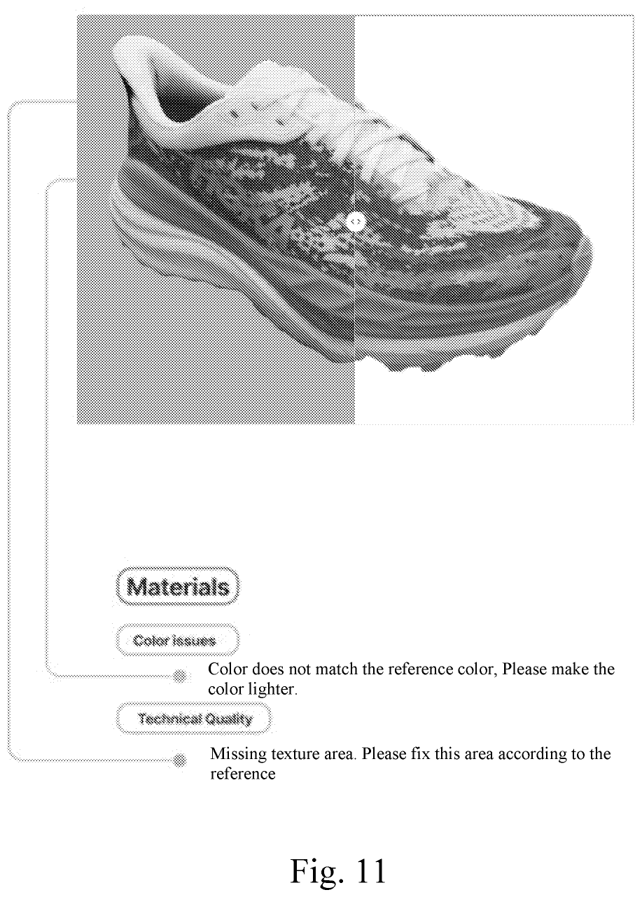

FIGS. 9 to 11 provide optional examples of feedback that may be provided back to the designer of the 3D model of discrepancies that were found between the model and the reference image.

As seen in the provided examples, the feedback may be provided with comments formulated during the review process, either automatically by the system or manually by a user conducting the review of the model.

The feedback may serve as guidance to amendments/changes that are requested to the 3D model, which when addressed may result in an updated version of the 3D model that can be uploaded into the system.

Such an updated version of the 3D model may avoid the alignment phase, by relying on the unique camera matrix previously provided or derived during the alignment.

This flow of review and feedback may continue until a final version of the 3D model suitable for use has been obtained.

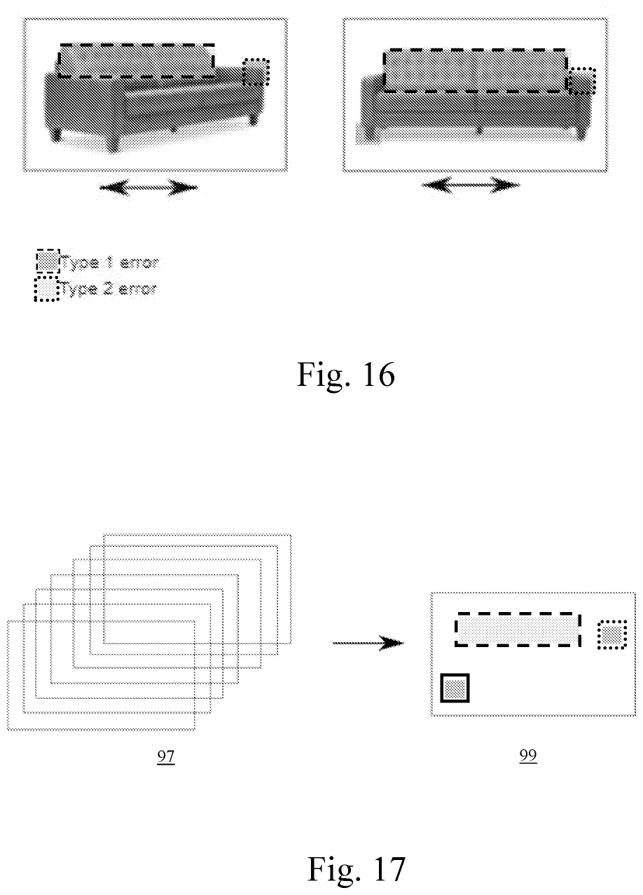

As seen in FIGS. 9 to 11 and with further attention drawn to the example also seen in FIG. 16—feedback of local analysis performed, e.g. in using the techniques described with respect to the review module 102, may be communicated to a user of the system by placing bounding boxes or segmentation masks on certain areas of the 3D model and/or a reference image.

Such results of local analysis may convey various types of information, such as also indication of a “type” of error that was detected. In the example seen in FIG. 16, an error of a 1st type is illustrated by a ‘dashed’ rectangle and that of a 2nd type by a ‘dotted’ rectangle. It is noted that others forms of marking errors may be used, such as colored boundaries or areas (or the like).

In an aspect of the present invention, input data analyzed during the review phase and the resulting analyzed output provided as feedback from the system, may be used for automating the quality control process by means of heuristic and/or Machine/Deep Learning algorithms.

As illustrated in FIG. 17, examples of input data 97 that may be used, may include on the image layer side any one of: R,G,B (or equivalently L,A,B or H,S,V) values of reference image(s) used for creating 3D models (and the like); and on the rendered model side any one of the following texture maps: diffuse, metallic, transparency, normal, depth (and the like). Examples of analyzed outputs 99 that may be used may include e.g. the resulting bounding box or segmentation mask types that were arrived at during the review process on the inputted data (as seen in FIGS. 9-11 and 16).

As aforementioned, such representation of corresponding regions over image layers lends itself to further automating the development of such algorithms using machine learning techniques, such as Convolutional Neural Networks, Transformers, and the like, in architectures such as YOLO, Mask R-CNN, etc.

In an aspect of the present invention, once a 3D model has been completed and approved according to criteria set during the production and quality control phases, such an approved 3D model may be used in a variety of ways.

For example, the 3D model may be placed in a website that can be accessed through the internet by a browser running on a user's computer or other internet-connected devices.

In order e.g. to reduce data transmission time, in certain cases it would be preferable to reduce the file size of a 3D model, while substantially not compromising on the visual quality to an extent determined by various criteria.

In at least certain embodiments, a computerized system of the present invention may be configured to compress a finalized approved 3D model prior to its usage over the internet, according to criteria relating to the visual quality of such a compressed model.

A 3D model may typically be represented by a mesh representation of polygons, such as triangular, quadrilateral (also referred to as ‘quad mesh’) and the like—and in certain embodiments a compression algorithm may be configured to reduce the number of polygons (e.g. triangles) in order to reduce the file size of the model.

Reducing the amount of polygons may be in various ways, such as by deleting some polygons, re-meshing (for example replacing two triangles with one—where the new one is not necessarily one of the two originals) and the like.

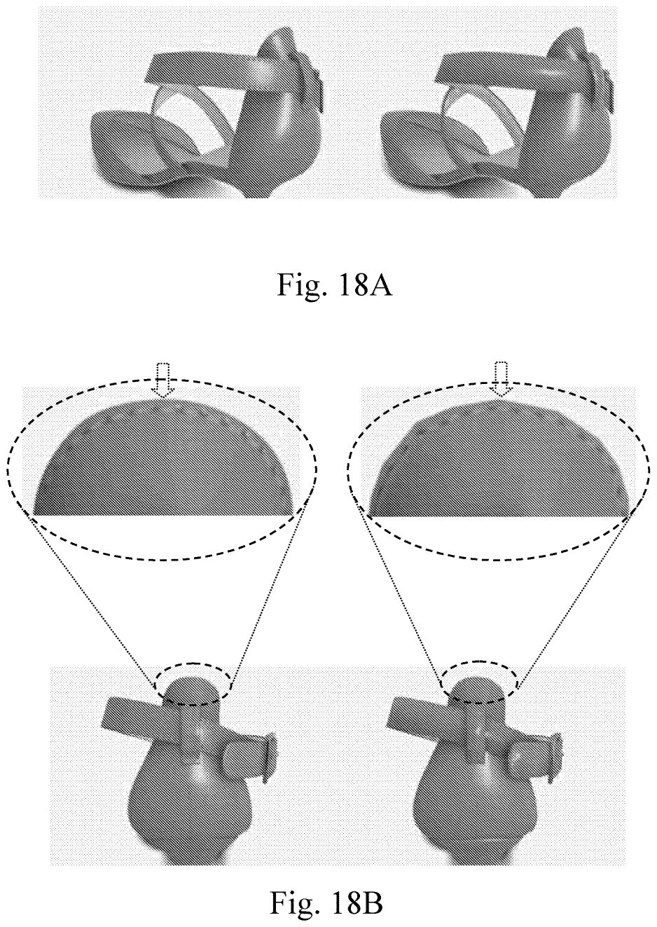

Attention is drawn to FIGS. 18A and 18B showing side by side, views of a completed 3D model prior compression (at the left hand sides) and after compression (at the right hand sides).

In certain embodiments, by placing these un-compressed and compressed model versions one next to the other-a UI of the system may be configured to enable visual comparison between the two model versions in order to visually identify the differences/defects created by the compression process.

In certain embodiments (now shown), the compressed and un-compressed 3D models may be placed one on top of the other in order to assist in such comparison (in a similar manner placement of rendered images of the 3D model during production over a reference image, as discussed herein above).

If for example, detectable degradation in the model may be identified, compression parameters may be tuned to produce a higher quality compressed version that may then be compared again—until a satisfactory result is achieved and released for use.

In the enlarged sections provided in FIG. 18B—one can observe on the compressed version of the 3D model (see right-hand side) degradation in smoothness of the model in this region as pointed to by the dotted arrow—that is not preset in this same region (see left-hand side) in the model before compression.

In certain embodiments, areas on the compressed 3D model where degradation in the quality of the 3D model may be detected—may be marked (e.g. by bounding boxes or the like). Such marking of degraded areas on the 3D model may be manually, semi-automatic or fully automatic.

In certain embodiments, a system may be configured for setting the compression parameters globally or locally. For example, while setting a certain compression level (e.g. 70% compression) to the full model, if a specific area on the 3D model may be detected as being visually degraded (e.g. the area of the 3D model seen in the enlarged right-hand side section in FIG. 18B) then a local lower compression level may be set for this area (e.g. 20% compression) in order to improve the compressed model in this area.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A method for production of a three dimensional model comprising the steps of:
providing at least one reference image of an item,
providing a three dimensional model of the same item, and
obtaining parameters of a unique camera matrix in which a rendering of the three dimensional model appears substantially similar to the at least one reference image.

2. The method of claim 1, wherein the at least one reference image is of a real world item.

3. The method of claim 1, wherein the three dimensional model is created using the at least one reference image.

4. (canceled)

5. The method of claim 1, wherein the parameters of the unique camera matrix are obtained by aligning the three dimensional model to the at least one reference image.

6. The method of claim 5, wherein the at least one reference image is a plurality of reference images, and a unique camera matrix suitable for comparing the three dimensional model to each one of its given reference images is obtained and associated to each given reference image and its three dimensional model.

7. (canceled)

8. (canceled)

9. The method of claim 8 5, wherein the parameters of the unique camera matrix are stored and associated with each three dimensional model and each one of its reference images.

10. The method of claim 7 5 and comprising a step of reviewing the rendering of the three dimensional model with respect to each given reference image when using the unique camera matrix associated with the given reference image for viewing the three dimensional model.

11. The method of claim 10, wherein the step of reviewing comprises comparing between texture parameters of each given reference image and the rendering of the three dimensional model.

12. The method of claim 10, wherein the step of reviewing comprises using scene lighting parameters of a certain viewer that is intended to be used for viewing the 3D model by an end user.

13. The method of claim 11, wherein the step of reviewing comprises using a rendering engine of the same certain viewer.

14. The method of claim 10, wherein the step of reviewing comprises comparing between geometrical parameters of each given reference image and the rendering of the three dimensional model.

15. The method of claim 10 and comprising a step of providing feedback on the three dimensional model based on differences detected between the three dimensional model and its reference image(s).

16. (canceled)

17. The method of claim 1 and comprising a step of approving a 3D model obtained according to the production steps as ready for use.

18. The method of claim 17, wherein the use of the 3D model is by placing the 3D model in a website that can be accessed through the internet by a browser running on a user's computer or other internet-connected devices.

19. The method of claim 17, wherein prior to use the approved 3D model undergoes compression.

20. (canceled)

21. The method of claim 19 and comprising a step of comparing between the compressed and un-compressed versions of the approved 3D model.

22. The method of claim 21 and being configured to permit changing of compression parameters during the comparing step upon detection of differences between the compressed and un-compressed versions of the approved 3D model that are above a certain threshold.

23. (canceled)

24. A system for producing a three dimensional model and being configured to:
present to a user at least one reference image of an item,
upload a three dimensional model of the same item, and
compute for each given reference image parameters of a unique camera matrix in which a rendering of the three dimensional model appears substantially similar the given reference image.

25-37. (canceled)

38. A method for producing a three dimensional (3D) model comprising the steps of:
providing a user viewer for use during the production or quality assurance of the three dimensional model,
providing a client viewer where the produced 3D model is intended to be used/viewed after production,
providing at least one reference image of an item,
providing a three dimensional model of the same item, and
obtaining parameters of a unique camera matrix in which a rendering of the three dimensional model on the user viewer appears substantially similar to the at least one reference image, wherein
the rendering on the user viewer comprises using the same rendering engine as being used by the client viewer.

39. The method of claim 38, wherein the rendering on the user viewer comprises using the same scene lighting as being used by the client viewer.
